(19) United States
(12) Patent Application Publication
(10) Pub. No.: US 2024/0317899 A1
(43) Pub. Date: Sep. 26, 2024

(54) METHOD FOR THE MANUFACTURE OF AGAR OR AGAROSE BEADS USING NATURAL OR VEGETABLE OIL

(71) Applicant: BIO-WORKS SWEDEN AB, Uppsala (SE)

(72) Inventors: Mikael ANDERSSON-SCHÖNN, Uppsala (SE); Fredrik PETERSSON, Uppsala (SE); Alexander IDSTRÖM, Göteborg (SE); Xiao HUANG, Uppsala (SE); Olof HAGLUND, Uppsala (SE); Lars HANESKOG, Vattholma (SE)

(21) Appl. No.: 18/576,296

(22) PCT Filed: Jul. 15, 2022
(86) PCT No.: PCT/SE2022/050719

§ 371 Date: Jan. 3, 2024

(30) Foreign Application Priority Data
Jul. 15, 2021 (SE) 2150945-0

(51) Int. Cl. C08B 37/00; B01J 20/24; B01J 20/285; B01J 20/291; C08J 3/16; C08L 5/12

(52) U.S. Cl. CPC C08B 37/0039; B01J 20/24; B01J 20/285; B01J 20/291; C08J 3/16; C08L 5/12; B01J 2220/4825; C08J 2305/12

(57) ABSTRACT

A method for the manufacture of agar or agarose beads, the method comprising the steps of: i) providing a water phase comprising an aqueous solution of agar or agarose at a temperature above the gelling temperature of said aqueous solution; ii) providing an oil phase comprising a natural or vegetable oil at a temperature above the gelling temperature of the aqueous solution provided in step i); iii) combining the water phase provided in step i) with the oil phase provided in step ii) in a reactor, and adding an emulsifier; iv) emulsifying the mixture obtained in step iii), preferably by agitating the mixture, thereby creating an emulsion; v) performing a stepwise cooling comprising a first cooling step for cooling the emulsion obtained in step iv) to a temperature 0.1-30 degrees C. above the gelling temperature of the aqueous solution provided in step i), followed by a second cooling step for emptying the reactor from the emulsion and passing the emulsion through a heat exchanger, thus resulting in cooling of the emulsion to a temperature below the gelling temperature of the aqueous solution provided in step i); and vi) recovering of agar or agarose beads from said emulsion.

### TECHNICAL FIELD

The present invention relates generally to a method of manufacturing agar or agarose beads suitable to be used as chromatographic resin, by emulsifying a mixture using natural or vegetable oil.

### BACKGROUND ART

Agarose beads for separation purposes have been commercially available for five decades. Conventionally, agarose beads are obtained by emulsifying a warm solution of agarose in a hot water immiscible solvent to form a water-in-oil (W/O) emulsion, following by cooling the emulsion below the gelling temperature of agarose thus forming beads particles. These are then collected in a subsequent separation step. Such a process has previously been described, for instance in PORATH J ET AL, Journal of Chromatography, vol. 60, 1 Jan. 1971, US2018071484 and WO1989011493.

An important parameter in agarose beads, to be used as chromatographic resin, is their porosity. The porosity is controlled by different parameters during the production, however cooling of the emulsifying solution is one of the most crucial ones. To achieve a desired porosity range in the beads, controlling the cooling and the temperature gradient during cooling of the emulsified mixture is essential.

Traditionally, the water immiscible solvent used as the continuous phase of the emulsion is usually selected from an organic solvent, for instance toluene. Toluene, due to its low viscosity, provides good control over cooling and is thus advantageous when producing beads with controlled porosity and size. Such a process is for instance disclosed in WO2020221762. However, in recent years growing environmental concerns has driven the industry to develop methods of production avoiding the usage of organic solvents, and substitute these partly or completely with natural or vegetable alternatives. Moreover, the usage of organic solvents like toluene also poses other problems such as danger of explosion and concerns about working health and safety.

Agar consists of agarose and agaropectin, usually with a ratio between agarose to agaropectin of between 90:10 to 70:30. Both agarose and agaropectin are polysaccharides with alternating anhydrogalactose and galactose subunits, i.e. their polysaccharide skeletons are the same. Agaropectin is significantly sulphated and therefore negatively charged. Moreover, it is also methylated meaning that it contains methoxy groups. Agarose is in essence uncharged and without sulphate groups. Both agar, in particular desulphated agar, and agarose were initially suggested as starting materials for the manufacture of cross-linked separation gels. See for instance U.S. Pat. No. 3,959,251 (Porath et al). However, during the years people have focused more on agarose than on agar, most likely due to the high content of sulphate groups of agar (present in agaropectin) and problems with removing the sulphate groups without negatively affecting the quality of the agar base material.

It has previously been shown that it is possible to substitute an organic solvent as the continuous phase in a water-in-oil emulsion when producing agarose beads with vegetable oil, such as in NICOLAS IONNIDIS ET AL, Journal of Colloid and Interface Science 367 (2012), and CHEN ET AL, Journal of Separation Science, vol 40, 22/17. However, these results are all produced in lab scale, thus in very small volumes.

Due to significantly higher viscosity of vegetable oils compared to organic solvents, it is more difficult to control the cooling of an emulsion comprising vegetable oil as the continuous phase. When emulsifying in a smaller scale, this is less of a problem due to the smaller volumes handled, and jacket cooling of the reactor is thus a suitable option for cooling an emulsion comprising a highly viscous continuous phase. However, this is not an option in an industrially scaled production, as jacket cooling combined with the higher viscosity of vegetable oil would result in a slow and uncontrolled cooling, thus resulting in beads with impaired shape, size and porosity properties. Slow cooling results in a relative high porosity. A fast cooling results in smaller pores.

It would be advantageous to produce agar or agarose beads by a method not utilizing organic solvents such as toluene in an industrially viable process. Further, it would be advantageous to produce agar or agarose beads with a controlled size and/or porosity distribution.

### SUMMARY OF INVENTION

An object of the present invention is to reduce or eliminate one or more of the above shortcomings by providing an improved method for producing agar or agarose beads.

Another object of the invention is to provide a method for the manufacture of agar or agarose beads using a water-in-oil (W/O) emulsion comprising a natural or vegetable oil as the continuous phase (oil phase). Thereby, a method eliminating or reducing the usage of low viscosity organic solvents is achieved.

Another object of the invention is to provide a method for the manufacture of agar or agarose beads, comprising a cooling step suitable to be used in an industrially scaled production.

Another object of the present invention is to provide a method for the manufacture of agar or agarose beads, wherein said method results in agar or agarose beads with a controlled size distribution and shape.

Another object of the present invention is to provide a method for the manufacture of agar or agarose beads, wherein said method results in agar or agarose beads with a controlled porosity.

Another object of the present invention is to provide a method for the manufacture of agar or agarose beads, wherein said method reduces or eliminates oil inclusions in the beads.

Another object of the present invention is to provide agar or agarose beads suitable to be used as chromatographic resin.

In one general embodiment of the invention, a method for the manufacture of agar or agarose beads is provided, the method comprising the steps of:
i) providing a water phase comprising an aqueous solution of agar or agarose at a temperature above the gelling temperature of said aqueous solution;
ii) providing an oil phase comprising a natural or vegetable oil at a temperature above the gelling temperature of the aqueous solution provided in step i);
iii) combining the water phase provided in step i) with the oil phase provided in step ii) in a reactor, and adding an emulsifier;
iv) emulsifying the mixture obtained in step iii), preferably by agitating the mixture, thereby creating an emulsion;
v) performing a stepwise cooling comprising a first cooling step for cooling the emulsion obtained in step iv) to a temperature 0.1-30 degrees C. above the gelling temperature of the aqueous solution provided in step i), followed by a second cooling step for emptying the reactor from the emulsion and passing the emulsion through a heat exchanger, thus resulting in cooling of the emulsion to a temperature below the gelling temperature of the aqueous solution provided in step i); and
vi) recovering of agar or agarose beads from said emulsion.

By a method according to the present invention, a more controlled particle size distribution and porosity is achieved. Without being bound to theory, it is believed that by subjecting the emulsion to a stepwise cooling, thus first bringing the emulsion to a temperature close to but still above the gelling temperature of the aqueous solution of agar or agarose, results in a reduced viscosity difference between the cooling start and the point of gelling, i.e. the temperature where the “viscous” beads turn to gelled (i.e. solid) beads. This reduced temperature and viscosity difference between the starting temperature where the beads are still in their viscous form and the temperature under the gelling temperature, i.e. where the beads will be in their gelled (i.e. solidified) form, results in an easier control of the temperature gradient. This in turns leads to a better control of the temperature affected parameters such as size distribution and porosity, which are highly affected by cooling rate. Controlling the cooling is of crucial importance when having an emulsion comprising a continuous phase exhibiting higher viscosity, and hence a more challenging temperature control during cooling compared to conventional organic solvents.

By subjecting the emulsion to a final cooling through a heat exchanger, a fast cooling with a controlled temperature gradient is achieved. This results in the possibility to control the temperature profile of the gelling and therefore controlling the size distribution and porosity of the resulting beads. Furthermore, by achieving a fast and controlled cooling, it is possible to utilize the method in an industrially scaled production, even if a highly viscous continuous phase is utilized in the water-in-oil (W/O) emulsion.

The water phase comprising an aqueous solution of agar or agarose may be native agar, native agarose or a derivate of agar or agarose, as for instance described in WO2008136742 and U.S. Pat. No. 6,602,990, hereby incorporated by reference in their entireties.

The gelling temperature of an agar or agarose solution is usually above 40 degrees C. However, small variations from this value occurs depending on the amount and purity of agar present in the solution. A skilled person however is expected to know about these and understands that such variations exist. In one embodiment of the present invention, the water phase comprising an aqueous solution of agar or agarose is provided at a temperature above 40 degrees C., preferably at a temperature between 40-99 degrees C., preferably between 40.1-99.9 degrees C. and even more preferably between 41 degrees C. to 95 degrees C.

In one embodiment of the present invention, the oil phase is provided at a temperature above 40 degrees C., preferably at a temperature between 40-99 degrees C., preferably between 40.1-99.9 degrees C. and even more preferably between 41 degrees C. to 95 degrees C.

In one embodiment, the emulsifier is added to the combined solution after both the water phase and the oil phase have been combined. Preferably, the emulsifier is added after that the water phase has been added to the oil phase.

In one embodiment, step iv) of emulsifying the mixture can be performed by any conventional emulsifying method known to the skilled person.

The first cooling step for cooling the emulsion obtained in step iv) cools the emulsion to a temperature 0.1-30 degrees C. above the gelling temperature of the aqueous solution provided in step i). In one embodiment, the first cooling step cools the emulsion to a temperature of 0.5-15 degrees C. above the gelling temperature of the aqueous solution provided in step i), preferably to a temperature of 0.5-10 degrees C. above the gelling temperature of the aqueous solution provided in step i), even more preferably to a temperature of 0.5-5 degrees C. above the gelling temperature of the aqueous solution provided in step i). In one embodiment, the first cooling step cools the emulsion to a temperature of 40.5-49 degrees C., preferably to a temperature of 41-45 degrees C.

By cooling in a stepwise manner according to the present invention, it is possible to utilize a more viscous oil-phase compared to organic solvents, as the cooling will be performed in a fast, controlled, and convenient manner.

Recovering of the agar or agarose beads from the formed emulsion can be performed by any conventional means known to the skilled person. In one embodiment, the beads are recovered by sedimentation of the beads in the presence of excess water, and optionally a surfactant to separate the beads from the water phase.

In one embodiment of the invention, step iii) is performed by adding the aqueous solution from step i) to the oil phase provided in step ii) in the reactor, preferably by pouring the aqueous solution from step i) into the reactor containing the oil phase from step ii). The inventors have surprisingly found out that the addition method highly affects the formation of beads in the emulsion. Traditionally when emulsifying using a low viscous solvent like toluene, the toluene is added to the water phase. However, if this addition method is used on more viscous oil like a vegetable oil, the subsequently formed beads will exhibit oil inclusions impairing the quality. The inventors have solved this problem by instead adding the water phase to the oil phase. Preferably, the addition of the water phase to the oil phase is done in a controlled manner, for instance by pouring or dripping, in order to ensure a more homogenous distribution and avoiding flocculations. Also, the temperature of the water phase when added to the oil phase has been shown to affect the final properties of the beads. Preferably, the water phase is added at a temperature of above 70 degrees C., preferably above 80 degrees C., preferably above 90 degrees C. and even more preferably above 95 degrees C.

In one embodiment of the invention, step iii) and step iv) are performed simultaneously. In one embodiment of the invention, step iv) is started after the water phase has been added to the oil phase.

In one embodiment of the invention, the first cooling step is performed by cooling the emulsion in the reactor to a temperature of 0.1-20 degrees C. above 40 degrees C., preferably to a temperature of 1-10 degrees C. above 40 degrees C., even more preferably to a temperature of 1-5 degrees C. above 40 degrees C. As previously described, cooling the emulsion to a temperature close to the gelling temperature of the aqueous solution of agar or agarose solution (i.e. the water phase), reduces the viscosity gap between the cooling start and the gelling temperature of the beads. This in turn results in a more controlled temperature gradient and controlled parameters such as porosity and size distribution of the beads.

In one embodiment of the invention, the second cooling step results in cooling the emulsion to a temperature below 30 degrees C., preferably below 25 degrees C. By cooling to a temperature bellow the gelling temperature of the aqueous solution of agar or agarose solution (i.e. the water phase), beads are achieved.

The natural oil may be oil obtained from varied parts of an oil containing plant, for instance oils from seeds, fruits, leaves, flowers, stems, barks or roots. In one embodiment of the invention, the vegetable oil is selected from rapeseed oil, corn oil, sunflower oil, peanut oil or another plant based oil. Preferably the vegetable oil is rapeseed oil. Rapeseed oil has been shown to exhibit the best viscosity properties to ensure a controlled cooling of the emulsion.

In one embodiment of the invention, the agitation in step iv) is performed by an overhead mixer, preferably between 1000-2000 rpm, even more preferably between 1250-1750 rpm. Traditionally when manufacturing agar or agarose beads, a high shear mixer is used. However, when using an oil with a higher viscosity than conventional organic water immiscible solvents, high shear mixing results in oil inclusions in the beads. Without being bound to theory, it is believed that the increased viscosity leads to an increased mechanical impact on the beads when mixing compared to the same process in a low viscous oil phase. However, it has been shown that a high viscous oil phase allows for good particle distribution of the beads by using a conventional mixer with high speeds. The speed of the mixer (revolutions per minute or rpm) has been shown to have an impact on the beads size distribution. An increased speed leads to stronger shear effects and a decreased Dv50 value of the beads. Dv50 means that 50% of the product in weight is below a specific micron size. A high speed can also result in that the continuous phase (oil phase) is forced within the formed emulsion spheres, thus resulting in an emulsion within the emulsion which will impair the properties of the resulting beads. A too low speed will not result in an emulsion.

In one embodiment of the invention, the second cooling step comprises passing the emulsion through a series of heat exchangers. By using a series of heat exchangers, it is possible to provide different cooling settings and thereby controlling the cooling gradient differently.

In one embodiment of the invention, the second cooling step comprises passing the emulsion through a 100-700 KW heat exchanger, preferably through a 600-700 KW heat exchanger. Preferably, the water temperature through the heat exchanger is between 5-20 degrees C., even more preferably between 7-15 degrees C.

In one embodiment of the invention, the volume ratio between the water phase and the oil phase is between 1:9 to 1:1, preferably between 1:4 to 1:1, preferably between 2:5 to 5:8. A high volume of water phase relative to volume of oil phase results in a higher Dv50 value.

In one embodiment on the invention, the emulsifier is a nonionic surfactant, preferably the emulsifier is a sorbitan ester. In one embodiment, the emulsifier is selected from the SPAN family, preferably the emulsifier is selected from Span™ 80, Span™ 85, or a mixture thereof. The type of emulsifier affects the beads size and also the geometry of the beads. Poorly chosen emulsifier may cause bead flocculation and oil inclusions. The emulsifier lowers the interfacial tension between the oil phase and the water phase in order to facilitate the division into smaller droplets and to stabilize them. Poor interaction usually leads to malformations. To achieve spherical agar or agarose beads when using a high viscous oil phase, emulsifiers selected from sorbitan esters, i.e. SPANs, have been shown to create minimal amount of deformed beads and maintain a good size distribution.

The emulsifier is charactered by its HLB value. The HLB value is an index of the solubilizing properties of emulsifiers and indicates the type of emulsion (O/W or W/O) that the emulsifier is best suited for. In a water-in-oil (W/O) emulsion a low HLB is preferable as it means a higher solubility in the continuous phase (oil phase), which contributes to a greater proportion of beads being within a controlled size range compared to emulsifiers with higher HLB values.

In one embodiment of the invention, the mixture obtained in step iii) comprises an amount of emulsifier of between 10-20 g/L oil phase, preferably between 12.5-17.5 g/L oil phase.

In one embodiment of the invention, step iv) is performed at 60-95 degrees C.

In one embodiment of the invention, the aqueous solution of agar or agarose comprises 1-9 wt % agar or agarose, preferably between 3-8 wt % agar or agarose, even more preferably approximately 7 wt % agar or agarose. The agar or agarose content of the aqueous solution determines the viscosity of the water phase in the emulsion. The viscosity is crucial in determining how well the phase will be mixed and thus the size of the obtained beads in the emulsion. An increased agar content generally contributes to larger, dense beads with a lower porosity value. Moreover, a high agar content seems to reduce the amount of oil inclusions. A lower agar content requires less energy input to shear and thus emulsify the mixture.

In one embodiment of the invention, the volume ratio between the water phase and the oil phase is 2:8.

In one embodiment of the invention, the water phase may further comprise at least one salt. The salt increases the gelling temperature while at the same time decreasing the viscosity. In one embodiment of the invention, the water phase may further comprise an acid. A lower pH decreases the viscosity of the water phase and affects the gel strength. In one embodiment of the invention, the oil phase may further comprise a foam inhibitor.

In a second general embodiment of the invention, agar or agarose beads obtained by the method according to any of the previous embodiments are provided. The beads exhibit a porosity measured in K_{d} Thyroglobulin of between 0.20-0.35, and further more than 50% of the beads exhibit a size between 30-75 μm.

In one embodiment of the invention, more than 55% of the beads exhibit a size between 30-75 μm.

In gel filtration, distribution of a particular compound between the inner and outer mobile phase is a function of its molecular size, which is represented by distribution coefficient (K_{d}). The larger molecules which are usually excluded from the gel beads, such molecules will have a K_{d} value of 0. Certain molecules which are smaller than the pore size of the gel beads enters the pores in the gel matrix hence they will have a K_{d} value of 1. For molecules of intermediate size, they will have K_{d} value between 0-1. This type of variation in the K_{d} values makes it possible to separate molecules in the narrow molecular size range.

### BRIEF DESCRIPTION OF DRAWINGS

The invention is now described, by way of example, with reference to the accompanying drawings, in which:

FIG. 1 shows a 10× microscope image of agarose beads produced by emulsion of agar solution in rapeseed oil using different addition speeds of agar solution to the oil-phase. FIG. 1 is divided in a left half and a right half, the halves being separated by a dashed line.

FIG. 2 shows a 10× microscope images of agarose beads produced by emulsion of agar solution in rapeseed oil using different addition techniques. FIG. 2 is divided in a left half and a right half, the halves being separated by a dashed line.

FIG. 3 shows a 10× microscope images of agarose beads produced by emulsion of agar solution in rapeseed oil and toluene, respectively. FIG. 3 is divided in a left half and a right half, the halves being separated by a dashed line.

### DETAILED AND EXEMPLIFYING DESCRIPTION OF THE INVENTION

As used herein, “wt %” refers to weight percent of the ingredient referred to of the total weight of the compound or composition referred to.

As used herein, “approximately” should be interpreted as being as accurate as the method used to measure the value referred to.

The present invention relates to a method for the manufacture of agar or agarose beads, suitable to be used as chromatographic resin. Said method utilizes a water-in-oil (W/O) emulsion comprising a natural or vegetable oil as the oil phase (continuous phase). When the resulting emulsion is cooled by stepwise cooling according to the present invention, gelled (solidified) beads are formed. The stepwise cooling according to the present invention enables to usage of said method in an industrially scaled process, as the cooling is done in a fast, convenient, and controlled manner.

As previously described, when substituting a low viscous organic solvent like toluene to a highly viscous vegetable oil, several problems arise due to the different nature of the oil-phase. With increasing viscosity, the temperature control of the cooling becomes more challenging. Without a controlled temperature gradient, it is more difficult to control parameters such as size distribution and pore size of the resulting beads. The increased viscosity also poses a problem in how to combine the different phases to each other.

### Method of Combining the Oil and Water Phase Together

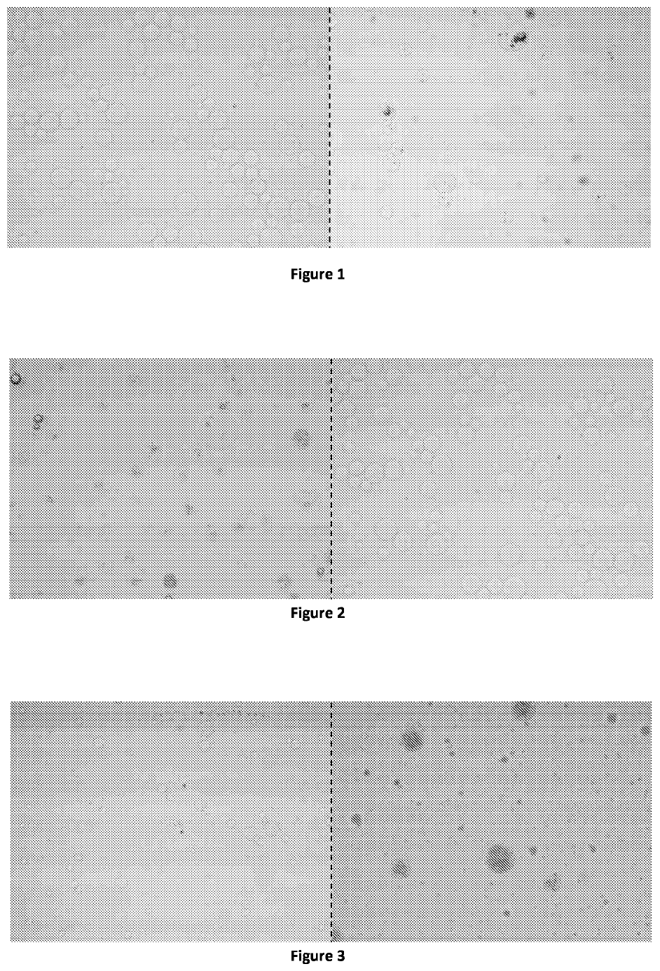

As previously discussed, how the dispersed phase (water phase) is added to the system has been shown to be of great importance if the viscosity of the continuous phase is high (oil phase). If a low viscosity continuous phase like toluene is used, no difference in the final product has been demonstrated between adding continuous phase to agar solution or vice versa. Nor does the addition rate seem to affect the result in this case. In the case of highly viscous continuous phase (rapeseed oil), however, the presence of oil inclusions in the final product occurs if the agar is added too quickly (see FIG. 1) or if the oil is instead added to the agar (“reverse” emulsification) (see FIG. 2).

FIG. 1 shows a 10× microscope image of agarose beads produced by emulsion of agar solution in rapeseed oil. The beads are produced using a standard emulsion consisting of 4:1 rapeseed oil to agar solution (7%) and 15 g/L oil phase of Span™ 85, agitated with overhead stirrer (1500 rpm) at 90° C. A step wise cooling is performed, with a first cooling step performed to cool the emulsion to 40° C. in the reactor and then a second cooling step via a 115 kW heat exchanger. The left half of FIG. 1 shows beads produced by slow addition of agar solution to the oil-phase. The right half of FIG. 1 shows beads produced with rapid addition of agar solution to oil. As can be seen in FIG. 1, a rapid addition results in oil inclusion in the beads (see the right half of FIG. 1).

FIG. 2 shows a 10× microscope images of agarose beads produced by emulsion of agar solution in rapeseed oil. The beads are produced using a standard emulsion consisting of 4:1 rapeseed oil to agar solution (7%) and 15 g/L oil phase of Span™ 85, agitated with overhead stirrer (1500 rpm) at 90° C. A step wise cooling is performed, with a first cooling step performed to cool the emulsion to 40° C. in the reactor and then a second cooling step via a 115 KW heat exchanger. The left half of FIG. 2 shows beads produced with the addition of oil to agar solution. The right half of FIG. 2 shows beads produced with the addition of agar solution to oil. As can be seen in FIG. 2, if oil is added to an agar solution, oil inclusion in the beads occurs (see the left half of FIG. 2). This phenomenon is not seen if an agar solution is added to oil instead.

The agar should also preferably be added warm (approx. 95° C.) to avoid local gelation

### Mixer Type and RPM (Revolutions Per Minute)

Traditionally when manufacturing agar or agarose beads, a high shear mixer is used to effectively create small drops in the desired size range. However, this method cannot be used in an emulsion with a highly viscous continuous phase as this would results in oil inclusions. Without being bound to theory, it is believed that the increased viscosity leads to an increased mechanical impact on the beads when mixing compared to the same process in a low viscous oil phase. However, it has been shown that a high viscous oil phase allows for good particle distribution of the beads by using a conventional mixer with high speeds.

As can be seen in FIG. 3, the speed of the mixing highly affects the beads distribution. FIG. 3 shows a 10× microscope images of agarose beads produced by emulsion of agar solution in rapeseed oil and toluene, respectively. The beads are produced using an emulsion consisting of 4:1 oil phase to 20% agar solution (7%) and 15 g/L oil phase of Span™ 85, agitated with high sheer mixer at 8000 rpm at 90° C. A step wise cooling is performed, with a first cooling step performed to cool the emulsion to 40° C. in the reactor and then a second cooling step via a 115 KW heat exchanger. The left half of FIG. 3 shows beads produced in toluene. The right half of FIG. 3 shows pearls in rapeseed oil. As can be seen, if a high sheer mixer is used with rapeseed oil, the quality of the beads is impaired (see the right half of FIG. 3). The beads shown in FIG. 1 and FIG. 2 produced by using a lower rpm shows less oil inclusion and an overall better distribution.

### Ratio Between Dispersed Phase (Water Phase) and Continuous Phase (Oil Phase)

As previously described, the ratio between dispersed phase (water phase) and continuous phase) highly affects the size distribution and pore size of the beads. Table 1 shows the outcome of an experimental series based on 8 different experiments, where 4 different parameters have been studied and their impact on Dv50 and percentage of beads between 30-75 μm. The parameter that has by far the greatest impact in this series of experiments is the ratio between dispersed phase and continuous phase (AgOil).

Dv50 means that 50% of the product in weight is below a specific micron size.

TABLE 1

| | | | Ratio water | | | | |
|---|---|---|---|---|---|---|---|
| Exp | | | phase to oil | Time | | | % (30- |
| No | RPM | Temp | phase | (min) | Dv(50) | Dspread | 75 μm) |
| 1 | 5000 | 60 | 0.2 | 10 | 59.5 | 85.5 | 51.92 |
| 2 | 7000 | 60 | 0.2 | 30 | 91.1 | 105.5 | 28.48 |
| 3 | 5000 | 80 | 0.2 | 30 | 98.7 | 119.2 | 23.48 |
| 4 | 7000 | 80 | 0.2 | 10 | 92 | 91.2 | 24.93 |
| 5 | 5000 | 60 | 0.4 | 30 | 155 | 134 | 0.9 |
| 6 | 7000 | 60 | 0.4 | 10 | 163 | 164 | 0.5 |
| 7 | 5000 | 80 | 0.4 | 10 | 152 | 141 | 1.39 |
| 8 | 7000 | 80 | 0.4 | 30 | 161 | 143.3 | 0.01 |

### Emulsifier

In a water-in-oil emulsion, a low HLB is preferable as it means a higher solubility in the continuous (non-polar) phase, which contributes to a larger proportion of population beads being within the range of 30-75 μm compared to emulsifiers from same chemical family but with higher HLB value. Two different emulsifiers from the SPAN-family having different HLB values were studied. The results are presented in Table 2. Table 2 describes differences in particle distribution for beads emulsified with Span™ 80 and Span™ 85. The beads are produced using a standard emulsion consisting of 4:1 rapeseed oil to agar solution (5.3%) and 15 g/L oil phase of Span™ 85, agitated with overhead stirrer (1500 rpm) at 90° C. A step wise cooling is performed, with a first cooling step performed to cool the emulsion to 55° C. in the reactor and then a second cooling step via a 115 KW heat exchanger.

As shown in Table 2, a lower HLB value results in more beads within a specific size range, and also a narrower size distribution overall.

TABLE 2

| | | | Beads within | Dv | Dv | Dv |
|---|---|---|---|---|---|---|
| Ex. | | HLB- | specification | (10) | (50) | (90) |
| number | Emulsifier | value | (30-75 μm) (%) | (μm) | (μm) | (μm) |
| EXP036- | Span ™ 80 | 4.3 | 20.54 | 43.2 | 110 | 206 |
| 023 | | | | | | |
| EXP036- | Span ™ 85 | 1.8 | 49.39 | 33.2 | 69 | 131 |
| 025 | | | | | | |

### First Cooling Step

As previously described, by using a stepwise cooling where the first cooling step cools the emulsion to a temperature close to the gelling temperature of the agar or agarose solution, results in a greater size control. Table 3 shows the effect the first cooling step has on the size of the beads. The table describes differences in particle distribution for beads cooled from different temperatures, i.e. the temperature of the first cooling step varies. The beads are produced using a standard emulsion consisting of 4:1 rapeseed oil to agar solution (7%) and 15 g/L oil phase of Span™ 85, agitated with overhead stirrer (1500 rpm) at 90° C. The cooling has taken place first to the specified temperature in the reactor (first cooling step) and then via a 115 KW heat exchanger (second cooling step).

As can be seen, by increasing the starting temperature of the second cooling step (higher temperature of the first cooling steep), less beads within a desired size specification are achieved. The conclusion from this experiment is that the temperature of the first cooling step highly affects the size distribution of the beads.

TABLE 3

| | Temp. first | Beads within | | | |
|---|---|---|---|---|---|
| Ex. | cooling step | specification | Dv (10) | Dv (50) | Dv (90) |
| number | (C. °) | (30-75 μm) (%) | (μm) | (μm) | (μm) |
| EXP029- | 40 | 57.09 | 28.8 | 59.7 | 104 |
| 230 | | | | | |
| EXP036- | 70 | 51.32 | 28.5 | 63.9 | 115 |
| 073 | | | | | |
| EXP036- | 90 | 35.09 | 36.4 | 83.7 | 151 |
| 074 | | | | | |

### Cooling Technique

Various cooling techniques have been evaluated; cooling in a reactor, cooling in a cooling vessel and cooling with the aid of a heat exchanger. The results are presented in Table 4. The beads are produced using a standard emulsion consisting of 4:1 rapeseed oil to agar solution (4.7%) and 15 g/L oil phase of Span™ 85, agitated with overhead stirrer (1500 rpm) at 90° C.

Cooling in a reactor was performed by allowing cold tap water to flow through the jacket of the reactor while the hot emulsion mixture was under stirring. This method gave a prolonged homogeneous cooling of the emulsion mixture. Cooling with this method gives porous beads with, relative to other cooling methods, high K_{d} values which also tend to be slightly softer (see Table 4). However, this type of cooling sometimes leads to the beads flocking and forming permanent aggregates.

Cooling in a cooling vessels was performed by allowing the hot emulsion liquid to be poured onto cold a cooling medium. This causes immediate cooling to the final temperature. This rapid cooling results in the beads becoming less porous, which is reflected in lower K_{d} values. However, extra refrigerant is required, in the form of a continuous phase, as well as open vessels, which is not necessary in the other methods. As a consequence, this method is not optimal for industrially scaled production.

Cooling by means of heat exchangers was performed by allowing the hot emulsion mixture to flow through a cooled heat exchanger. This gives beads with equivalent porosity properties such as cooling in cooling vessels, i.e. beads with a relatively low K_{d} value.

As can be seen in Table 4, cooling in a heat exchanger resulted in a larger amount of beads within a desired size specification, as well as a narrower size distribution compared to other cooling techniques.

TABLE 4

| | | Beads within | | | Pressure |
|---|---|---|---|---|---|
| | Cooling | specification | Dv (50) | K_{d} | resistance |
| Ex. number | technique | (30-75 μm) (%) | (μm) | thyroglobulin | (ml/min) |
| EXP036-060 | In a reactor | 52.87 | 64.3 | 0.47 | 10 |
| EXP036-028 | Heat | 67.89 | 55.4 | 0.38 | 10 |
| | exchanger | | | | |
| EXP036-032 | Cooling | 65.96 | 56.6 | 0.34 | 10 |
| | vessel | | | | |

### Effect of Stepwise Cooling on the Porosity

In the following example, the effect of stepwise cooling on the porosity of the formed beads was studied. As previously described, by subjecting the emulsion to a stepwise cooling, thus first bringing the emulsion to a temperature close to but still above the gelling temperature of the aqueous solution of agar or agarose, and then cooling the emulsion below the gelling temperature, enables an easier control of the cooling temperature gradient. The porosity of the formed beads is highly affected by the rate of cooling.

An aqueous agar solution is produced comprising 7% agar in water. The aqueous solution is heated to a temperature of 94 degrees C. and poured under stirring into an oil phase comprising rapeseed oil and Span 85. The combined aqueous agar solution and oil phase is stirred at 980 RPM at 94° C. The resulting emulsion consisting of 4:1 rapeseed oil to aqueous agar solution (7%) oil, and 15 g/L oil phase of Span™ 85.

A first cooling step is performed to cool the emulsion to 43° C. in the reactor. The cooled emulsion is then transferred to a 660 KW heat exchanger connected to cooled tap water at 12° C. The emulsion is cooled to 14-18° C. and the formed agar beads are recovered.

The porosity measured in K_{d} Thyroglobulin of the resulting beads is shown in table 5.

TABLE 5

| | First cooling | Second cooling | |
|---|---|---|---|
| | temperature | temperature of | K_{d} |
| Ex. number | of emulsion | emulsion | Thyroglobulin |
| EXP036-003 | 43° C. | 14-18° C. | 0.26 |

As can be seen, the K_{d} Thyroglobulin value is substantially lower compared to the beads presented in table 4 produced using a single cooling step and utilising a similar agar concentration. The method thus results in agar beads exhibiting a porosity comparable to available commercial agar beads, formed using toluene as oil phase.

1. A method for the manufacture of agar or agarose beads, suitable to be used as chromatographic resin, wherein the method comprising the steps of:
i) providing a water phase comprising an aqueous solution of agar or agarose at a temperature above the gelling temperature of said aqueous solution;
ii) providing an oil phase comprising a natural or vegetable oil at a temperature above the gelling temperature of the aqueous solution provided in step i);
iii) combining the water phase provided in step i) with the oil phase provided in step ii) in a reactor, and adding an emulsifier;
iv) emulsifying the mixture obtained in step iii), preferably by agitating the mixture, thereby creating an emulsion;
v) performing a stepwise cooling comprising a first cooling step for cooling the emulsion obtained in step iv) to a temperature 0.1-30 degrees C. above the gelling temperature of the aqueous solution provided in step i), followed by a second cooling step for emptying the reactor from the emulsion and passing the emulsion through a heat exchanger, thus resulting in cooling of the emulsion to a temperature below the gelling temperature of the aqueous solution provided in step i); and
vi) recovering of agar or agarose beads from said emulsion.

2. The method according to claim 1, wherein step iii) is performed by adding the aqueous solution from step i) to the oil phase provided in step ii) in the reactor, preferably by pouring the aqueous solution from step i) into the reactor containing the oil phase from step ii).

3. The method according to claim 1, wherein step iii) and step iv) are performed simultaneously.

4. The method according to claim 1, wherein the first cooling step is performed by cooling the emulsion in the reactor to a temperature of 0.1-20 degrees C. above 40 degrees C., preferably to a temperature of 1-10, preferably to a temperature of 1-5 degrees C. above 40 degrees C.

5. The method according to claim 1, wherein the second cooling step results in cooling the emulsion to a temperature below 30 degrees C., preferably below 25 degrees C.

6. The method according to claim 1, wherein the vegetable oil is selected from rapeseed oil, corn oil, sunflower oil, peanut oil or another plant based oil.

7. The method according to claim 1, wherein the agitation in step iv) is performed by an overhead mixer, preferably between 1000-2000 rpm, even more preferably between 1250-1750 rpm.

8. The method according to claim 1, wherein the second cooling step comprises passing the emulsion through a series of heat exchangers.

9. The method according to claim 1, wherein the second cooling step comprises passing the emulsion through a 100-700 KW heat exchanger, preferably through a 600-700 KW heat exchanger.

10. The method according to claim 1, the volume ratio between the water phase and the oil phase is between 1:9 to 1:1, preferably between 1:4 to 1:1, preferably between 2:5 to 5:8.

11. The method according to claim 1, wherein the emulsifier is a nonionic surfactant, preferably the emulsifier is a sorbitan ester.

12. The method according to claim 1, wherein the mixture obtained in step iii) comprises an amount of emulsifier of between 10-20 g/L oil phase, preferably between 12.5-17.5 g/L oil phase.

13. The method according to claim 1, wherein step iv) is performed at 60-95 degrees C.

14. The method according to claim 1, wherein the aqueous solution of agar or agarose comprises 1-9 wt % agar or agarose, preferably between 3-8 wt % agar or agarose, even more preferably approximately 7 wt % agar or agarose.

15. Agar or agarose beads, obtained by the method according to claim 1, wherein the beads exhibit a porosity measured in Kd Thyroglobulin of between 0.20-0.35 and wherein more than 50% of the beads exhibit a size between 30-75 μm.

16. The agar or agarose beads according to claim 15, wherein more than 55% of the beads exhibit a size between 30-75 μm.
